(19) United States
(12) Patent Application Publication
(10) Pub. No.: US 2010/0280180 A1
(43) Pub. Date: Nov. 4, 2010

(54) Thermoplastic Resin Composition

(75) Inventors: Byung-Choon LEE, Anyang-si (KR); Tae-Uk KIM, Suwon-si (KR); Young-Jun LEE, Yongin-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/836,111

(22) Filed: Jul. 14, 2010

Related U.S. Application Data
(63) Continuation-in-part of application No. PCT/KR2008/007911, filed on Dec. 31, 2008.

(30) Foreign Application Priority Data
Jan. 15, 2008 (KR) 10-2008-0004407

(51) Int. Cl. C08L 83/04

(52) U.S. Cl. 525/100

(57) ABSTRACT

A thermoplastic resin composition includes (A) 60 to 96 parts by weight of a polycarbonate resin, (B) 3 to 30 parts by weight of a polyalkyl(meth)acrylate resin having a weight average molecular weight of 30,000 g/mol or less, and (C) 1 to 10 parts by weight of polydialkyl-diarylsiloxane. The thermoplastic resin composition according to the present invention can have excellent scratch resistance and can be used in molded articles requiring high coloring properties such as exterior parts, vehicle precision parts, and the like.

### CROSS-REFERENCE TO RELATED APPLICATIONS

This application is a continuation-in-part of International Application No. PCT/KR2008/007911, filed Dec. 31, 2008, pending, which designates the U.S., published as WO 2009/091156, and is incorporated herein by reference in its entirety, and claims priority therefrom under 35 USC Section 120. This application also claims priority under 35 USC Section 119 from Korean Patent Application No. 10-2008-0004407, filed Jan. 15, 2008, in the Korean Intellectual Property Office, the entire disclosure of which is also incorporated herein by reference.

### FIELD OF THE INVENTION

The present invention relates to a thermoplastic resin composition.

### BACKGROUND OF THE INVENTION

Polycarbonate resins can have excellent toughness, impact resistance, thermal stability, self-extinguishing properties, dimensional stability, and heat resistance. Accordingly, polycarbonate resins have been used in electric and electronic products such as mobile phone housings, backlight frames, and connectors; vehicle parts such as head lamps, instrument panels, and the like; and as a substitute material for glass in applications requiring transparency and impact resistance such as lenses.

However, when a polycarbonate resin is used in a product requiring such transparency, it can cause problems of deteriorating scratch characteristics and manifestation of a browning phenomenon when it is exposed to sunlight for a long time.

Polycarbonate resin can be blended with polymethyl methacrylate (PMMA) resin to provide both excellent weather resistance and transparency, as well as excellent adhesiveness, strength such as bending strength, and curve deforming ratio. Accordingly, such blends can be used as an adhesive, a lightening material, and a construction material. However, because the impact strength of polycarbonate/PMMA resin blends can be less than that of other thermoplastic resins, its use can be limited in materials having a thickness of less than a certain level that is sufficient to endure an impact.

Nonetheless, when a transparent polycarbonate resin having high toughness and a transparent PMMA resin having high scratch resistance are alloyed, the alloy may provide both excellent impact resistance and excellent scratch resistance.

However, according to Japanese Patent Application No. 1993-130731, when polycarbonate resin and polymethyl methacrylate are alloyed, peeling may occur when the resins have a molecular weight outside a defined range and are used in an amount outside of a defined ratio due to the difference between the refractive index of the resins and lack of miscibility between the resins. In addition, the alloy may have a heterogeneous color and opaque characteristics.

There have been efforts to improve the scratch resistance of polycarbonates. Examples of methods used to improve scratch characteristics of polycarbonate resin include using an acrylic-based UV coating and treating the surface of a polycarbonate product with a Si compound, such as disclosed in U.S. Pat. No. 4,027,073. Other examples include blending polycarbonate with syndiotactic PMMA (U.S. Pat. No. 5,338,798), blending polycarbonate containing fluorinated bisphenol monomer units with PMMA (U.S. Pat. No. 5,292,809), and using single phase blends of polycarbonate and polyalkylmethacrylate (U.S. Pat. No. 4,743,654). However, the compounds can be very expensive and typically must be used within a defined range.

### SUMMARY OF THE INVENTION

An exemplary embodiment of the present invention provides a thermoplastic resin composition that can have excellent scratch resistance, impact resistance, and transparency by using a polycarbonate and polyalkyl(meth)acrylate resin having a low molecular weight, and polydialkyl-diarylsiloxane in a certain ratio. Another embodiment of the present invention provides a molded product made using the thermoplastic resin composition.

The embodiments of the present invention are not limited to the above technical purposes, and a person of ordinary skill in the art can understand other technical purposes.

According to one embodiment of the present invention, a thermoplastic resin composition is provided that includes: (A) 60 to 96 parts by weight of a polycarbonate resin; (B) 3 to 30 parts by weight of a polyalkyl(meth)acrylate resin having a weight average molecular weight of 30,000 g/mol or less; and (C) 1 to 10 parts by weight of polydialkyl-diarylsiloxane.

According to another embodiment of the present invention, a molded product is provided that is made using the thermoplastic resin composition.

Hereinafter, further embodiments of the present invention will be described in detail.

The thermoplastic resin composition according to the present invention can have excellent scratch resistance, impact resistance, and transparency, and can be used in various articles such as exterior parts of electric and electronic products requiring a high coloring property, vehicle precision parts, and the like.

### DETAILED DESCRIPTION OF THE INVENTION

The present invention now will be described more fully hereinafter in the following detailed description of the invention and with reference to the accompanying drawings, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “alkyl” refers to a C1 to C6 alkyl, and the term “aryl” refers to a C6 to C12 aryl.

The thermoplastic resin composition according to one embodiment of the present invention includes: (A) 60 to 96 parts by weight of a polycarbonate resin; (B) 3 to 30 parts by weight of a polyalkyl(meth)acrylate resin having a weight average molecular weight of 30,000 g/mol or less; and (C) 1 to 10 parts by weight of polydialkyl-diarylsiloxane.

Exemplary components included in the thermoplastic resin composition according to embodiments of the present invention will hereinafter be described in detail. However, these embodiments are only exemplary, and the present invention is not limited thereto.

### (A) Polycarbonate Resin

The polycarbonate resin may be prepared by reacting one or more dihydric phenols with phosgene in the presence of a molecular weight regulator and a catalyst, or by ester-interchange reaction of one or more dihydric phenols with a carbonate precursor. The polycarbonate resin may further include a multi-functional aromatic compound and/or a difunctional carboxylic acid.

Exemplary dihydric phenols include bisphenols, such as but not limited to 2,2-bis (4-hydroxyphenyl)propane (bisphenol A). The bisphenol A may be partially or wholly substituted with another dihydric phenol. Exemplary dihydric phenols other than bisphenol A may include without limitation halogenated bisphenols such as hydroquinone, 4,4′-dihydroxy diphenyl, bis(4-hydroxyphenyl)methane, 1 ,1 -bis(4-hydroxyphenyl)cyclohexane, 2,2-bis(3,5-dimethyl-4-hydroxyphenyl)propane, bis(4-hydroxyphenyl)sulfide, bis(4-hydroxyphenyl)sulfone, bis(4-hydroxyphenyl)sulfoxide, bis(4-hydroxyphenyl)ketone, bis(4-hydroxyphenyl)ether, 2,2-bis(3,5-dibromo-4-hydroxyphenyl)propane, and the like, and combinations thereof.

The carbonate precursor may include a diarylcarbonate such as diphenyl carbonate, or a cyclic carbonate such as ethylene carbonate.

The polycarbonate resin (A) may include a homopolymer, a copolymer of two or more different dihydric phenols, or a mixture thereof. Exemplary polycarbonate resins (A) may include without limitation linear polycarbonates, branched polycarbonates, polyestercarbonate copolymers, and the like, and mixtures thereof.

Exemplary linear polycarbonate resins include bisphenol A based polycarbonate resins. Exemplary branched polycarbonates may include one produced by reacting a multi-functional aromatic compound such as trimellitic anhydride, trimellitic acid, and the like with dihydroxy phenol and a carbonate precursor. Exemplary polyester carbonates may include one produced by reacting difunctional carboxylic acid with dihydric phenol and a carbonate precursor.

The thermoplastic resin composition may include polycarbonate resin (A) in an amount of 60 to 96 parts by weight, for example 80 to 95 parts by weight, based on the total weight of the thermoplastic resin composition. In some embodiments, the polycarbonate resin may be used in an amount of 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, or 96 parts by weight. Further, according to some embodiments of the present invention, the amount of the polycarbonate resin can be in a range from any of the foregoing amounts to any other of the foregoing amounts. When polycarbonate resin (A) is added in an amount within these ranges, the thermoplastic resin composition may exhibit excellent impact resistance.

### (B) Polyalkyl(meth)acrylate Resin

The polyalkyl(meth)acrylate resin can include a homopolymer of an alkyl(meth)acrylate monomer, such as methyl(meth)acrylate monomer, as the main or majority component (for example polymethylmethacrylate resin consisting of or including only methyl methacrylate monomer); a copolymer including units selected from the group consisting of alkylacrylates, alkylmethacrylates, and combinations thereof; or a mixture of one or more of the homopolymer(s) and/or one or more of the copolymer(s). Exemplary alkylacrylate and alkylmethacrylate monomers include without limitation methyl acrylate, methyl methacrylate, ethyl acrylate, ethyl methacrylate, butyl acrylate, butyl methacrylate, and the like, and combinations thereof.

In other exemplary embodiments, the polyalkyl(meth)acrylate resin can include 80 to 100% by weight of an alkyl (meth)acrylate unit and 0 to 20% by weight of a vinyl-based monomer that is not an alkyl (meth)acrylate.

In some embodiments, the polyalkyl(meth)acrylate resin includes an alkyl (meth)acrylate unit in an amount of 80, 81, 82, 83, 84, 85, 86, 87, 88, 89, 90, 91, 92, 93, 94, 95, 96, 97, 98, 99, or 100% by weight. Further, according to some embodiments of the present invention, the amount of an alkyl (meth)acrylate unit can be in a range from any of the foregoing amounts to any other of the foregoing amounts.

In some embodiments, the polyalkyl(meth)acrylate resin includes the vinyl-based monomer that is not an alkyl (meth)acrylate in an amount of 0, 1, 2, 3, 4, 5, 6, 7, 8, 9, 10, 11, 12, 13, 14, 15, 16, 17, 18, 19, or 20% by weight. Further, according to some embodiments of the present invention, the amount of the vinyl-based monomer that is not an alkyl (meth)acrylate can be in a range from any of the foregoing amounts to any other of the foregoing amounts.

Exemplary vinyl-based monomers include without limitation alkenyl aromatic monomers such as styrene, α-methyl styrene, vinyl toluene, vinyl benzyl methyl ether, and the like, unsaturated carbonic acid esters that are not alkyl (meth)acrylates such as 2-hydroxy ethyl acrylate, 2-hydroxy ethyl methacrylate, 2-hydroxy butyl acrylate, 2-hydroxy butyl methacrylate, benzyl acrylate, benzyl methacrylate, cyclohexyl acrylate, cyclohexyl methacrylate, phenyl acrylate, phenyl methacrylate, and the like; unsaturated carbonic acid aminoalkyl esters such as 2-amino ethyl acrylate, 2-amino ethyl methacrylate, 2-dimethyl amino ethyl acrylate, 2-dimethyl amino ethyl methacrylate, and the like; carbonic acid vinyl esters such as vinyl acetate, vinyl benzoate, and the like; unsaturated carbonic acid glycidyl esters such as glycidyl acrylate, glycidyl methacrylate, and the like; vinyl cyanide compounds such as acrylonitrile, methacrylonitrile, and the like; unsaturated amides such as acryl amide, methacryl amide, and the like; and combinations thereof.

The polyalkyl(meth)acrylate resin has a weight-average molecular weight of 30,000 g/mol or less. The conventional injection-molded polymethyl methacrylate resin that is commercially available has a weight-average molecular weight (Mw) of at least 60,000 g/mol. It is difficult to prepare a transparent blend when conventional commercially available polymethyl methacrylate resin with a weight-average molecular weight (Mw) of at least 60,000 g/mol is blended with a polycarbonate due to the refractive index difference between the two materials and the lack of compatibility thereof. By using polyalkyl(meth)acrylate resin having a low molecular weight, it is possible to improve the scratch resistance and transparency of the blend, as compared to a blend including a conventional polymethylmethacrylate, even when the polycarbonate and the polyalkyl(meth)acrylate resin having a low molecular weight are added in the same amount. According to one embodiment, the polyalkyl(meth)acrylate resin can have a weight-average molecular weight ranging from 5000 g/mol to 30,000 g/mol.

The polyalkyl(meth)acrylate resin having a low molecular weight can be prepared by conventional methods known to one having ordinary skill in the art. For example, polymethylmethacrylate can be obtained by polymerizing methylmethacrylate (MMA).

The thermoplastic resin composition includes the polyalkyl(meth)acrylate resin (B) in an amount of 3 to 30 parts by weight, for example 3 to 15 parts by weight, based on the total weight of the thermoplastic resin composition. In some embodiments, the thermoplastic resin composition includes the low molecular weight polyalkyl(meth)acrylate resin in an amount of 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the low molecular weight polyalkyl (meth)acrylate resin can be in a range from any of the foregoing amounts to any other of the foregoing amounts. When the polyalkyl(meth)acrylate resin (B) is added in an amount within these ranges, the thermoplastic resin composition can exhibit excellent scratch resistance and transparency.

### (C) Polydialkyl-diaryl Siloxane

Generally, polydimethyl siloxane has a low Tg (−160° C.), so it can be used for impact reinforcement for improving low temperature impact strength. However, polydimethyl siloxane can significantly deteriorate haze and transparency even if it is added in a small amount due to the refractive index difference between polydimethyl siloxane and polycarbonate. In the present invention, a part of the dialkyl groups of a polydialkyl siloxane such as polydimethyl siloxane is substituted with diaryl groups to improve refractive index and transparency when adding the polydialkyl-diaryl siloxane to a polycarbonate-based thermoplastic resin composition. Increasing the substitution ratio of diaryl can improve the refractive index, but it can be difficult to maintain the low Tg of dialkyl and it can also be difficult to improve low temperature impact strength. Accordingly, in the present invention, 30 to 50% of the dialkyl groups of the entire polydialkyl siloxane are substituted with diaryl groups.

Exemplary alkyl groups of the polydialkyl-diaryl siloxane can include without limitation methyl, ethyl, propyl, butyl, t-butyl, and the like, and combinations thereof, and exemplary aryl groups of the polydialkyl-diaryl siloxane can include without limitation phenyl, benzyl, tolyl, o-xylyl, m-xylyl, and the like, and combinations thereof.

The polydialkyl-diarylsiloxane can have a viscosity of 1 to 1000 centi-stokes (cSt) at 25° C., and in another embodiment, a viscosity of 4 to 500 centi-stokes (cSt). Using a polydialkyl-diaryl siloxane with a viscosity within these ranges can provide a balance of impact resistance and transparency.

In a further embodiment, the polydialkyl-diaryl siloxane is polydimethyl-diphenyl siloxane.

The thermoplastic resin composition includes the polydialkyl-diaryl siloxane (C) in an amount of 1 to 10 parts by weight, for example 1 to 5 parts by weight, based on the total weight of the thermoplastic resin composition. In some embodiments, the thermoplastic resin composition includes the polydialkyl-diaryl siloxane in an amount of 1, 2, 3, 4, 5, 6, 7, 8, 9, or 10 parts by weight. Further, according to some embodiments of the present invention, the amount of the polydialkyl-diaryl siloxane can be in a range from any of the foregoing amounts to any other of the foregoing amounts. When the polydialkyl-diaryl siloxane is added to the thermoplastic composition in an amount within the above ranges, it can provide a balance of transparency and impact resistance.

### (D) Other Additives

The thermoplastic resin having the composition may further include one or more other additives such as but not limited to a flame retardant, a lubricant, an antibiotic, a release agent, a nuclear agent, a plasticizer, a thermal stabilizer, an antioxidant, a light stabilizer, a compatibilizer, a pigment, a dye, an inorganic material additive, and the like, and combinations thereof.

Products may be produced from the thermoplastic resin of the invention using conventional methods. For example, the constituting components and other additives may be simultaneously mixed and melt-extruded through an extruder to provide the composition in pellet form. The pellets may be subject to conventional molding processes, such as but not limited to extrusion molding, injection molding, and the like, to form a product.

The thermoplastic resin composition can be used in a variety of articles, including without limitation vehicle precision parts and exterior parts of electric and electronic products such as TVs, computers, mobile phones, and office automation machinery requiring excellent scratch resistance, impact resistance, and coloring property.

Hereinafter, the present invention is illustrated in more detail with reference to examples. However, they are exemplary embodiments of present invention and are not limiting.

### EXAMPLES Each of the constituting components of thermoplastic resin compositions used in examples of the present invention and comparative examples are as follows.

(A) Polycarbonate Resin

A bisphenol-A linear polycarbonate having a weight-average molecular weight of 25,000 g/mol and PANLITE L-1250WP® manufactured by Japan TEIJIN are used.

(B-1) Polyalkyl(meth)acrylate

A polymethylmethacrylate having a weight-average molecular weight of 10,000 g/mol is used.

(B-2) Polyalkyl(meth)acrylate

A polymethylmethacrylate L-84® having a weight-average molecular weight of 95,000 g/mol manufactured by MRC is used.

(C) Polydialkyl-diarylsiloxane

TSF-433® having a viscosity of 450 cST manufactured by Momentive is used.

### Examples 1 to 3 and Comparative Examples 1 to 4

The components mentioned above are mixed in composition ratios shown in the following Table 1 and extruded by a twin screw extruder having φ=45 mm to provide a pellet. The amount unit of each composition is parts by weight in the following Table 1.

The obtained pellet is dried at 90° C. for 3 hours or more and extruded with a 10 oz extruder under the condition of a forming temperature of 220 to 280° C. and a molding temperature of 60 to 100° C. to provide a 3 mm thick flat sample.

TABLE 1

| | |
|---|---|
| Examples | Comparative Examples |

| | 1 | 2 | 3 | 1 | 2 | 3 | 4 |
|---|---|---|---|---|---|---|---|
| (A) | 92 | 90 | 85 | 85 | 90 | 40 | 100 |
| (B-1) | 3 | 5 | 10 | — | — | 50 | — |
| (B-2) | — | — | — | 10 | 10 | — | — |
| (C) | 5 | 5 | 5 | 5 | — | 10 | — |

The samples obtained from the above method are evaluated to determine physical properties in accordance with the following methods. The results are shown in the following Table 2.

(1) Scratch Resistance: a tungsten carbide stylus having a spherical point with a diameter of 0.7 mm is loaded with 1 kg and the surface is scratched at a speed of 75 mm/min to evaluate roughness with a surface roughness meter (surface profiler) to determine the scratch width.

(2) Impact resistance: impact resistance is measured by making a notch on a ⅛″ izod sample in accordance with ASTM D256.

(3) Transparency: the transparency of a 2.5 mm thick sample is measured with Gretag MacBeth Color-Eye 7000A equipment.

TABLE 2

| | Examples | | | Comparative Examples | | | |
|---|---|---|---|---|---|---|---|
| | 1 | 2 | 3 | 1 | 2 | 3 | 4 |
| Scratch | 320 | 310 | 300 | 312 | 310 | 250 | 335 |
| width (μm) | | | | | | | |
| Transparency | 92 | 90 | 83 | 66 | 68 | 3 | 98 |
| (%) | | | | | | | |
| IZOD (⅛″) | 65 | 63 | 60 | 58 | 42 | 8 | 60 |
| (kgf · cm/cm) | | | | | | | |

As shown in Table 2, Examples 1 to 3 in which a low molecular weight polymethyl methacrylate resin and polydialkyl-diarylsiloxane are added to polycarbonate resin in a certain ratio exhibit a superior balance of three kinds of physical properties, namely, scratch properties, transparency, and impact resistance, as compared to that of Comparative Examples 1, 2, and 4 that include only a polycarbonate resin or include polymethyl methacrylate having a generally high weight-average molecular weight. Further, as illustrated by Comparative Example 3, when the amount of a low molecular weight PMMA is more than 30 parts by weight, the product exhibits significantly deteriorated the transparency and impact resistance.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A thermoplastic resin composition comprising:
(A) 60 to 96 parts by weight of a polycarbonate resin;
(B) 3 to 30 parts by weight of a polyalkyl(meth)acrylate resin having a weight average molecular weight of 30,000 g/mol or less; and
(C) 1 to 10 parts by weight of polydialkyl-diarylsiloxane.

2. The thermoplastic resin composition of claim 1, wherein the polycarbonate resin (A) comprises a linear polycarbonate, a branched polycarbonate, a polyestercarbonate copolymer, or a mixture thereof.

3. The thermoplastic resin composition of claim 1, wherein the polyalkyl(meth)acrylate resin (B) has a weight average molecular weight of 5000 g/mol to 30,000 g/mol.

4. The thermoplastic resin composition of claim 1, wherein the polydialkyl-diarylsiloxane (C) is polydimethyl-diphenylsiloxane.

5. The thermoplastic resin composition of claim 1, wherein the polydialkyl-diarylsiloxane (C) comprises a polydialkyl siloxane in which 30 to 50% of the dialkyl groups of the polydialkyl siloxane are substituted with diaryl groups.

6. The thermoplastic resin composition of claim 1, wherein the polyalkyl(meth)acrylate resin (B) is polymethylmethacrylate resin.

7. A molded product made using a thermoplastic resin composition comprising:
(A) 60 to 96 parts by weight of a polycarbonate resin;
(B) 3 to 30 parts by weight of a polyalkyl(meth)acrylate resin having a weight average molecular weight of 30,000 g/mol or less; and
(C) 1 to 10 parts by weight of polydialkyl-diarylsiloxane.

8. The molded product of claim 7, wherein the polycarbonate resin (A) comprises a linear polycarbonate, a branched polycarbonate, a polyestercarbonate copolymer, or a mixture thereof.

9. The molded product of claim 7, wherein the polyalkyl(meth)acrylate resin (B) has a weight average molecular weight of 5000 g/mol to 30,000 g/mol.

10. The molded product of claim 7, wherein the polydialkyl-diarylsiloxane (C) is polydimethyl-diphenylsiloxane.

11. The molded product of claim 7, wherein the polydialkyl-diarylsiloxane (C) comprises a polydialkyl siloxane in which 30 to 50% of the dialkyl groups of the polydialkyl siloxane are substituted with diaryl groups.

12. The molded product of claim 7, wherein the polyalkyl(meth)acrylate resin (B) is polymethylmethacrylate resin.
